(19) United States
(12) Patent Application Publication
(10) Pub. No.: US 2016/0301051 A1
(43) Pub. Date: Oct. 13, 2016

(54) ASSEMBLED BATTERY

(71) Applicant: HITACHI AUTOMOTIVE SYSTEMS, LTD., Hitachinaka-shi, Ibaraki (JP)

(72) Inventors: Osamu KUBOTA, Tokyo (JP); Naoya TOKOO, Tokyo (JP); Takashi SUZUKI, Hitachinaka-shi (JP); Naoki KOJIMA, Hitachinaka-shi (JP)

(73) Assignee: HITACHI AUTOMOTIVE SYSTEMS, LTD., Hitachinaka-shi, Ibaraki (JP)

(21) Appl. No.: 15/037,144

(22) PCT Filed: Jan. 21, 2015
(86) PCT No.: PCT/IB2015/000049

§ 371 Date: May 17, 2016

(30) Foreign Application Priority Data
Nov. 22, 2013 (JP) 2013-241985

(51) Int. Cl. H01M 2/12; H01M 2/10

(52) U.S. Cl. CPC H01M 2/1217; H01M 2/1077; H01M 2220/20

(57) ABSTRACT

Provided is an assembled battery which can secure airtightness of a flow passage without a need of precise alignment when the flow passage is configured to discharge a gas released from a gas discharge valve and regardless of expansion/contraction of a battery. A battery holder includes a main body member which abuts on a wide surface of a battery housing in the direction of a thickness and an upper member of which one end is fixed to an upper end of the main body member and the other end abuts on an upper surface of the battery housing and is extended in the direction of the thickness. The upper member is formed to surround the gas discharge valve, and abuts on a lower surface of a gas conduit member to form a gas passage from the gas discharge valve to the gas conduit member.

### TECHNICAL FIELD

The present invention relates to an assembled battery in which a plurality of batteries are connected, and particularly to an assembled battery which includes a flow passage to discharge a gas released from a gas discharge valve of each battery.

### BACKGROUND ART

In recent years, development of a secondary battery such as a lithium-ion secondary battery having a high energy density as a power unit of an electric automobile is ongoing. The secondary battery may be overheated due to overcharging or short-circuit for example in some cases. In this case, for example, there is concern about that an internal pressure of the battery housing is steeply increased by a decomposition gas generated from a liquid electrolyte or an electrode in a battery housing or a gas generated from the gasified liquid electrolyte. A gas discharge valve is generally provided in the battery housing as a means for preventing an explosion of the battery housing by discharging the gas in the battery housing to lower the internal pressure at the time when the internal pressure of the battery housing is increased. In a case where the internal pressure of the battery housing is increased in exceed of a predetermined value, the gas discharge valve is, for example, cleaved and opened so as to release the gas in the battery housing to the outside.

In this way, there is known a power source device configured by a plurality of square battery cells, each of which is provided with a safety valve in a sealing plate by being opened at the time when the internal pressure is increased so as to release the inner gas (for example, see PTL 1 below). The power source device of PTL 1 includes a gas duct which is unidirectionally extended to guide the gas released from the safety valve, and a gas pipe which is air-tightly connected to the gas duct and guides the gas to a gas discharge port. The gas duct is air-tightly connected to each safety valve of each battery cell in a state where two or more battery blocks (each of which is configured by laminating a plurality of square battery cells with a separator therebetween) are disposed alongside in the lamination direction of the battery cells.

In addition, the gas duct is configured such that a duct coupling hole for the coupling with the gas pipe is open in one surface, and a plurality of valve coupling holes each for the coupling with the safety valves are open in the other surface. Then, the duct coupling hole is disposed in an axial line different from any one of the valve coupling holes. Based on such a configuration, the power source device disclosed in PTL 1 avoids a situation in which a high-pressure gas discharged from the safety valve directly hits and damages a coupling portion between the gas duct and the gas pipe, so that the coupling between the gas duct and the gas pipe is protected against the gas discharge at the time when the safety valve is operated.

### CITATION LIST

### Patent Literature

PTL 1: Japanese Patent Application Laid-Open No. 2010-287514

### SUMMARY OF INVENTION

### Technical Problem

The power source device disclosed in PTL 1 is necessarily connected to make the gas duct and the gas pipe accurately positioned in order to secure airtightness. However, the square battery cells and the separators used in the power source device each have a dimensional tolerance, and the square battery cells are expanded or contracted according to charging/discharging. Therefore, a positional deviation may occur between the gas duct and the gas pipe. When the positional deviation occurs between the gas duct and the gas pipe, it becomes difficult to secure the airtightness in the coupling portions.

The invention has been made in view of the above problems, and an objective thereof is to provide an assembled battery which can secure airtightness of a flow passage without a need of precise alignment when the flow passage is configured to discharge a gas released from a gas discharge valve and regardless of expansion/contraction of a secondary battery.

### Solution to Problem

In order to achieve the object, an assembled battery according to the present invention includes: a plurality of secondary batteries that includes a flat-box-shaped battery housing having a gas discharge valve in an upper surface; a battery holder that is alternately laminated with the secondary battery in a thickness direction of the secondary battery; and a gas conduit member that is disposed on an upper portion of the gas discharge valve, wherein the battery holder includes a main body member that abuts on a wide surface of the battery housing in the thickness direction, and an upper member of which one end is fixed to an upper end of the main body member and the other end abuts on an upper surface of the battery housing and is extended in the thickness direction, and wherein the upper member is formed to surround the gas discharge valve and abuts on a lower surface of the gas conduit member to form a gas passage from the gas discharge valve to the gas conduit member.

### Advantageous Effects of Invention

According to an assembled battery of the invention, a gas passage to communicate a fluid between a gas discharge valve of a secondary battery and a gas conduit member is formed using an upper member of which one end is fixed to an upper end of a main body member of a battery holder and the other end abuts on an upper surface of a battery housing and is extended in a thickness direction. Thus, a dimensional tolerance of the secondary battery and the battery holder can be allowed and an expansion/contraction of the secondary battery can be allowed by changing a gap between the other end of the upper member and another battery holder facing the other end. Therefore, there is no need to make precise alignment when a flow passage for discharging a gas released from the gas discharge valve is configured by the gas passage and the gas conduit member, and the dimensional tolerance of the secondary battery and the battery holder can be allowed and the airtightness of the flow passage can be secured by allowing the expansion/contraction of the secondary battery.

### BRIEF DESCRIPTION OF DRAWINGS

FIG. 1 is an exploded perspective view illustrating a first embodiment of an assembled battery of the invention.

FIG. 2 is a perspective view of a battery provided in the assembled battery illustrated in FIG. 1.

FIG. 3 is a perspective view of a battery holder provided in the assembled battery illustrated in FIG. 1.

FIG. 4 is a perspective view illustrating an assembled state of a secondary battery illustrated in FIG. 2 and the battery holder illustrated in FIG. 3.

FIGS. 5(a) to 5(c) are enlarged plan views illustrating dimensional tolerances of the battery holder and a battery housing in the assembled state illustrated in FIG. 4, in which FIGS. 5(a) to 5(c) each are enlarged plan views illustrating different dimensional tolerances.

FIGS. 6(a) and 6(b) are perspective views illustrating a gas conduit member, in which FIG. 6(a) is a perspective view of a gas conduit member of the first embodiment, and FIG. 6(b) is an exploded perspective view of a gas conduit member of a first modification.

FIG. 7 is an enlarged cross-sectional view taken along a line VII-VII after the assembled battery illustrated in FIG. 1 is assembled.

FIG. 8 is a perspective view illustrating the first modification of the battery holder provided in the assembled battery illustrated in FIG. 1.

FIG. 9 is a perspective view illustrating an assembled state of the battery holder of the first modification illustrated in FIG. 8 and the secondary battery.

FIG. 10 is a perspective view illustrating a second modification of the battery holder provided in the assembled battery illustrated in FIG. 1, in which an assembled state of the battery holder and the secondary battery of the second modification is illustrated.

FIG. 11 is an exploded perspective view illustrating a second embodiment of an assembled battery of the invention.

FIG. 12 is a perspective view of the battery holder provided in the assembled battery illustrated in FIG. 11.

FIG. 13 is an exploded perspective view illustrating the secondary battery illustrated in FIG. 11 and a pair of battery holders on both sides of the secondary battery.

FIG. 14 is an enlarged cross-sectional view of the assembled battery taken along a line XIV-XIV of FIG. 11.

FIGS. 15(a) and 15(b) are enlarged plan views illustrating the secondary battery illustrated in FIG. 13 and the pair of battery holders on both sides of the secondary battery in the assembled state, in which FIGS. 15(a) and 15(b) are enlarged plan views illustrating the vicinity of a gas discharge valve.

FIG. 16 is a perspective view illustrating a third modification of the battery holder provided in the assembled battery illustrated in FIG. 11.

### DESCRIPTION OF EMBODIMENTS

Hereinafter, embodiments of an assembled battery of the invention will be described with reference to the drawings. In the following description, “up”, “down”, “right”, and “left” merely indicate directions for the convenience of explanation on a positional relation of configurations, and it does not necessarily mean “up” and “down” in the vertical direction and “right” and “left” in the horizontal direction. In addition, in the respective drawings, scales, ratios, and dimensions may be appropriately indicated different from actual ones in order to help with easy understanding.

### First Embodiment

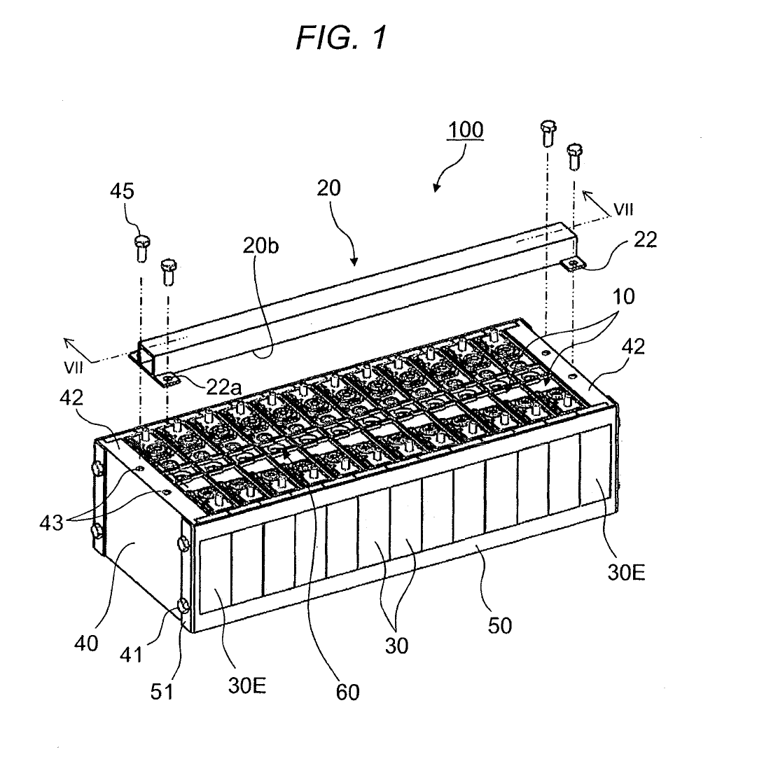

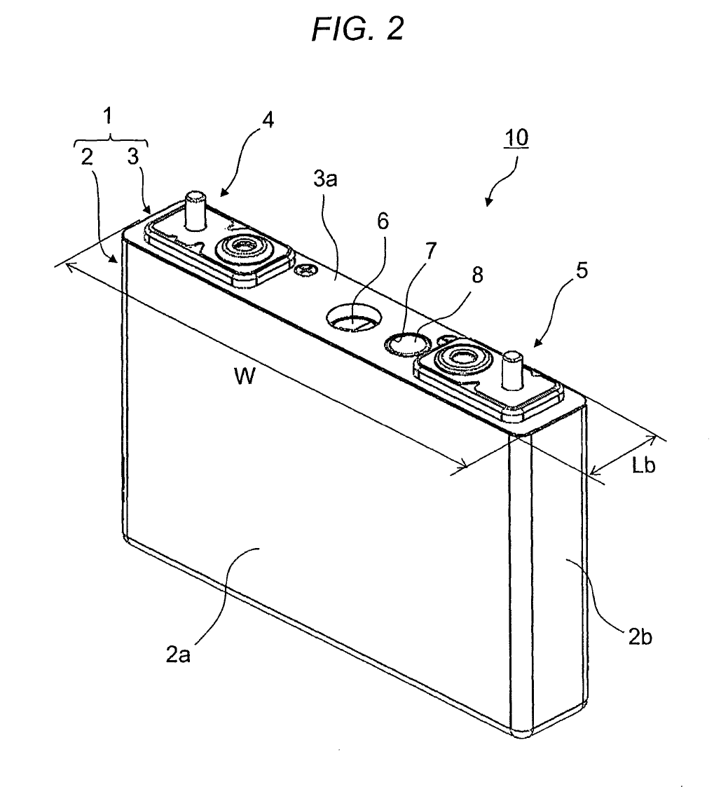

FIG. 1 is an exploded perspective view of an assembled battery 100 according to a first embodiment. FIG. 2 is a perspective view of a secondary battery 10 provided in the assembled battery 100 illustrated in FIG. 1.

### (Assembled Battery)

The assembled battery 100 of this embodiment includes the secondary battery 10 in which a gas discharge valve 6 is provided in an upper surface 3a of a flat-box-shaped battery housing 1, and a gas conduit member 20 which discharges a gas released from the gas discharge valve 6 to the outside. The assembled battery 100 is configured to contain a plurality of secondary batteries 10 which are laminated in a direction of the thickness Lb of the battery housing 1 with a battery holder 30 interposed therebetween. A pair of end battery holders 30E and 30E is disposed on both ends in a lamination direction of the secondary battery 10. On the outside of the pair of end battery holders 30E and 30E, a pair of end plates 40 and 40 and metal bands 50 and 50 are disposed to fasten and fix a laminated body which is configured by the secondary battery 10, the battery holder 30, and the end battery holder 30E.

The end plate 40 is, for example, a structural member of a substantial flat shape made by being cut out of a metal material of a block shape or a plate shape. The end plate 40 is formed in a rectangular shape corresponding to the shape of a wide surface 2a of the battery housing 1 in order to constrain a wider area of the wide surface 2a in a thickness direction of the battery housing 1 provided in the laminated secondary battery 10. The end plate 40 is slightly smaller than the wide surface 2a, and substantially equal to or slightly smaller than the size of the battery holders 30 and 30E facing the wide surface 2a. A screw hole is provided on both sides of the outer surface of the end plate 40 in the lamination direction of the secondary battery 10, and L-shaped coupling portions 51 on both sides of the metal band 50 are engaged with both sides of the pair of end plates 40 by screwing a bolt 41 into the screw hole. In addition, the upper end portion of the endplate 40 is provided with a coupling portion 42 which is bent at almost the right angle to form an L shape. A screw hole 43 is provided in the coupling portion 42, flange portions 22 on both ends in the longitudinal direction of the gas conduit member 20 traversing the assembled battery 100 in the lamination direction of the secondary battery 10 is fixed to the coupling portion 42 of the end plate 40 by screwing a bolt 45 into the screw hole 43.

The metal band 50 is, for example, formed in a rectangular frame shape by punching out the center portion of a rectangular metal plate having a predetermined thickness in a rectangular shape, and both end portions in the longitudinal direction are bent at almost the right angle so as to form the L-shaped coupling portion 51. A through hole is provided in the coupling portion 51 to make the bolt pass therethrough. The laminated body configured by the secondary battery 10, the battery holder 30, and the end battery holder 30E is fastened and fixed in the lamination direction by the pair of end plates 40 and the metal band 50 by inserting the bolt 41 into the through hole to engage the coupling portion 51 with the end plate 40. The metal band 50 is, for example, made of a steel material such as stainless steel, and designed in a dimension and a shape having a mechanical strength sufficient for fastening and fixing the laminated body configured by the secondary battery 10, the battery holder 30, and the end battery holder 30E.

### (Secondary Battery)

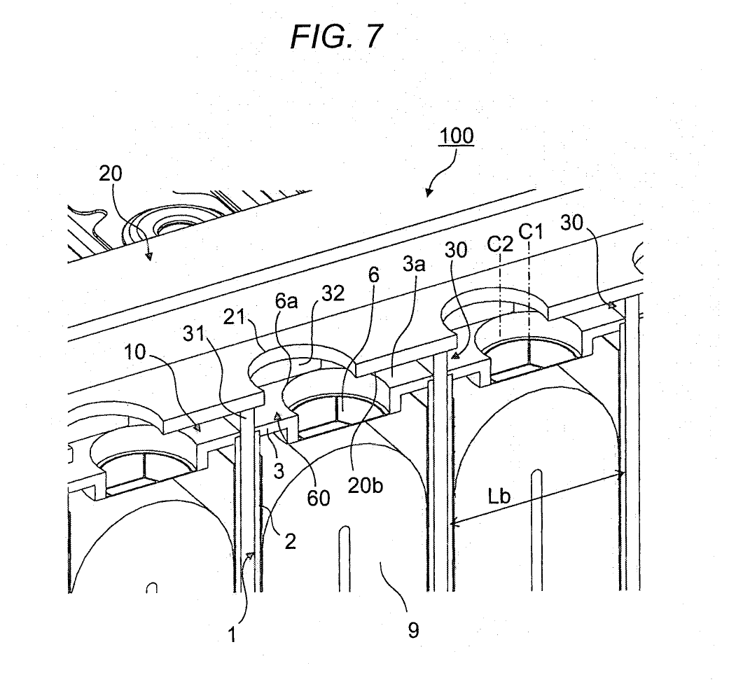

The secondary battery 10 provided in the assembled battery 100 of this embodiment is, for example, a lithium-ion secondary battery, and includes the flat-box-shaped battery housing 1 made of a metal such as aluminum or aluminum alloy. The battery housing 1 is configured by a battery can 2 of which the upper side is open in a bottomed rectangular cylindrical shape, and a battery lid 3 which is formed in a rectangular plate shape to block the upper opening of the battery can 2. In the battery can 2, there is contained a wound electrode group 9 (see FIG. 7) which is formed in a flat shape by winding positive and negative electrodes laminated with a separator interposed therebetween.

The battery lid 3 is welded, for example, by a laser welding over the entire peripheral edge of the upper opening of the battery can 2 to seal the battery can 2. A positive electrode external terminal 4 and a negative electrode external terminal 5 are provided in the battery lid 3, and the positive electrode and the negative electrode of the wound electrode group 9 each are electrically connected to the positive electrode external terminal 4 and the negative electrode external terminal 5 through a collector plate fixed to the battery lid 3. The battery lid 3 is electrically insulated from the positive electrode external terminal 4, the negative electrode external terminal 5, and the collector plate with, for example, a gasket made of an insulating material or an insulating plate disposed therebetween.

In addition, the gas discharge valve 6 is provided in the battery lid 3. The gas discharge valve 6 is formed thinner than, for example, the other portions of the battery housing 1, the secondary battery 10 is, for example, overheated by short-circuit or overcharging, and thus a slit is cleaved when an internal pressure of the battery housing 1 is increased up to a predetermined value, and the gas in the battery housing 1 is released to make the internal pressure lowered, so that the explosion of the battery housing 1 is prevented. The assembled battery 100 of this embodiment includes the gas conduit member 20 which discharges the gas released from the gas discharge valve 6 of the upper surface 3a of the battery housing 1 of the secondary battery 10 to the outside. The battery holders 30 interposing the secondary battery 10 from both sides of the lamination direction form a partition of a gas passage 60 through which a fluid communicates between the gas discharge valve 6 and the gas conduit member 20. The gas passage 60 partitioned by the battery holders 30 will be described in detail below.

The battery lid 3 is further provided with a liquid injection port 7. The liquid injection port 7 is used for injecting a liquid electrolyte into the battery housing 1 after the wound electrode group 9 is contained in the battery can 2 and the battery lid 3 is welded. After the liquid electrolyte is injected into the battery housing 1, the liquid injection port 7 is bonded and sealed with a metal cap 8 by a laser welding for example.

The secondary batteries 10 having the above configuration are laminated in the direction of the thickness Lb of the battery housing 1 with the battery holders 30 and 30E interposed therebetween. The positive electrode external terminal 4 and the negative electrode external terminal 5 of each secondary battery 10 are connected in series using, for example, bus bars, and supply power to an external device such as a motor of an electric automobile and charge the power supplied from an electric generator.

### (Battery Holder)

Next, the description will be made about the battery holders 30 and 30E partitioning the gas passage 60 as a featured portion of the assembled battery 100 of this embodiment. Further, the pair of end battery holders 30E and 30E disposed on both ends in the lamination direction of the plurality of secondary batteries 10 laminated with the battery holder 30 interposed therebetween is schematically configured such that the battery holder 30 disposed between the secondary batteries 10 is cut in half in the surface parallel to the wide surface 2a of the battery housing 1 of the secondary battery 10. Therefore, in the following description, the configuration of the battery holder 30 disposed between the secondary batteries 10 will be described, and the configuration of the end battery holder 30E will be not described.

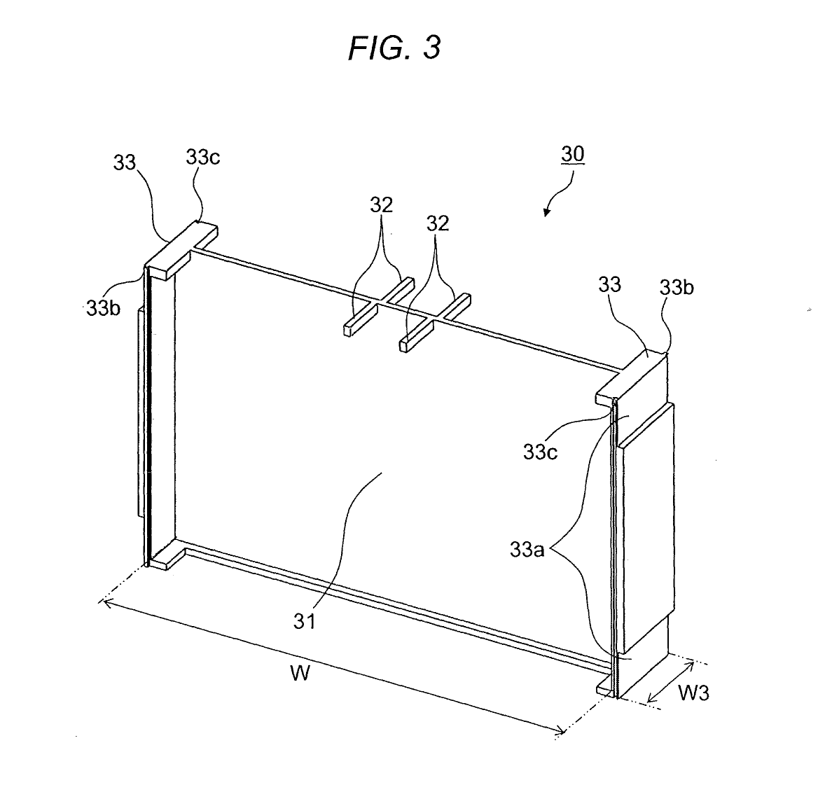

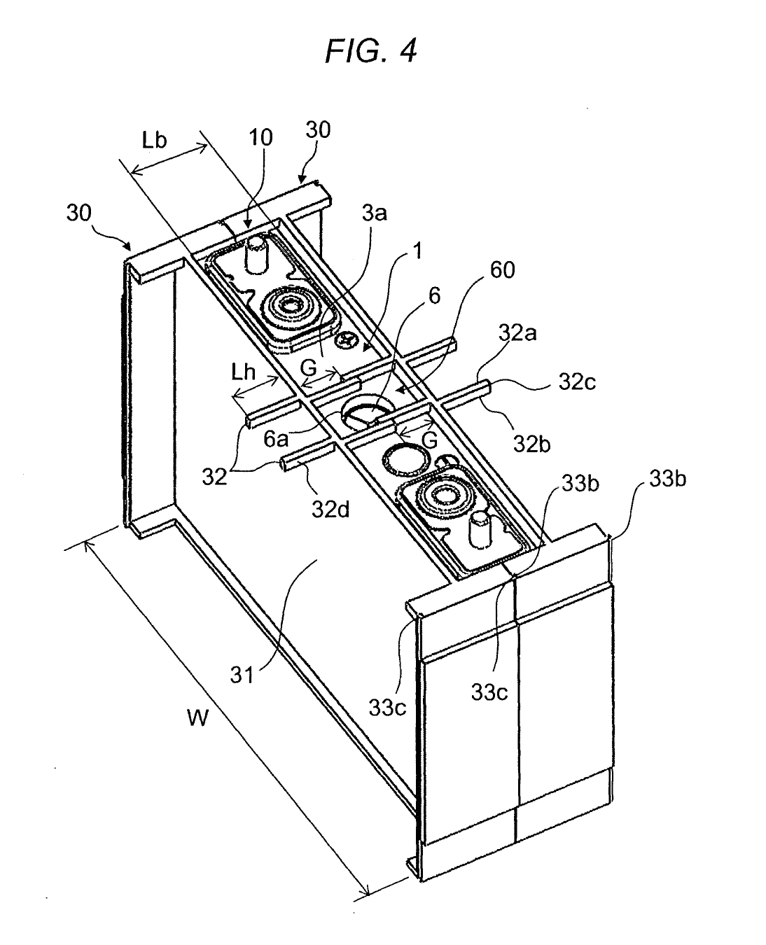

FIG. 3 is a perspective view of the battery holder 30 provided in the assembled battery 100 illustrated in FIG. 1. FIG. 4 is a perspective view illustrating an assembled state of the secondary battery 10 illustrated in FIG. 2 and the battery holder 30 illustrated in FIG. 3.

The battery holder 30 may be manufactured by being molded using, for example, engineering plastic such as PBT (polybutylene terephtalate) or PC (polycarbonate) or a material such as rubber having heat resistance and insulation property. The battery holder 30 includes a main body member 31 facing the wide surface 2a of the battery housing 1, an upper member 32 extending in the direction of the thickness Lb of the battery housing 1 along the upper surface 3a of the battery housing 1, and a side member 33 facing a narrow surface 2b of the battery housing 1.

The main body member 31 is formed in a flat shape, and abuts on the wide surface 2a of the battery housing 1 to constrain the wide surface 2a in a state where the secondary battery 10 and the battery holder 30 are laminated.

The upper member 32 is configured such that the one end thereof is fixedly supported to the upper end of the main body member 31 and the other end is a free end. As illustrated in FIG. 4, the battery holder 30 of this embodiment includes the upper members 32 on both sides of the gas discharge valve 6 in an assembled state where the battery holders 30 are disposed on both sides in the direction of the thickness Lb of the secondary battery 10. In other words, the battery holder 30 includes the upper members 32 on both sides of the gas discharge valve 6 in a direction along the upper surface 3a and the wide surface 2a of the battery housing 1 (for example, a direction of the width W of the battery housing 1 parallel to the upper surface 3a and the wide surface 2a). The upper members 32 and 32 of the pair of battery holders 30 and 30 form a partition of the gas passage 60, and surround an opening 6a of the gas discharge valve 6. Further, a lower surface 32b abuts on the upper surface 3a of the battery housing 1, an upper surface 32a abuts on a lower surface 20b of the gas conduit member 20, and the gas discharge valve 6 and the gas conduit member 20 communicate to make a fluid flow.

In other words, the upper members 32 and 32 of the pair of battery holders 30 and 30 facing each other in the direction of the thickness Lb of the battery housing 1 are extended in a direction facing each other, free ends 32c are overlapped in the direction of the width W of the battery housing 1, and side surfaces 32d and 32d in the direction of the width W abut on each other to form the gas passage 60. At this time, the pair of battery holders 30 and 30 facing each other in the direction of the thickness Lb of the battery housing 1 is desirable to have a gap G between the upper member 32 of the battery holder 30 and the other battery holder 30.

Herein, the length Lh of the upper member 32 along the direction of the thickness Lb of the battery housing 1 is desirably set as follows.

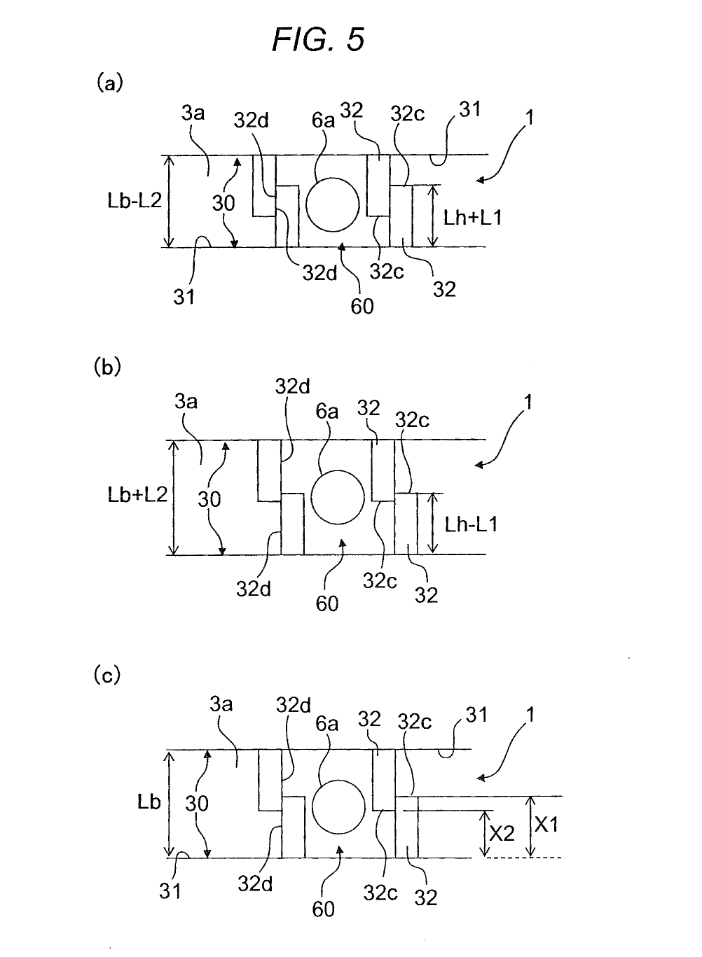

FIGS. 5(a), 5(b), and 5(c) are enlarged views illustrating the vicinity of the gas discharge valve 6 in plan view of the battery housing 1.

The length of the upper member 32 along the direction of the thickness Lb of the battery housing 1 is set to Lh, and the dimensional tolerance of the length Lh is set to ±L1. The dimensional tolerance of the thickness Lb of the battery housing 1 is set to ±L2. At this time, the length Lh of the upper member 32 is determined in consideration of a case where the thickness Lb of the battery housing 1 is maximized and minimized according to the dimensional tolerance ±L2 of the thickness Lb of the battery housing 1.

As illustrated in FIG. 5(a), there is assumed a case where the dimensional tolerance ±L2 of the thickness Lb of the battery housing 1 is a negative maximum value −L2 and the thickness Lb is minimized to be Lb−L2, and a case where the dimensional tolerance ±L1 of the length Lh of the upper member 32 is a positive maximum value +L1 and the length Lh of the upper member 32 is maximized to be Lh+L1. In this case, when the pair of facing battery holders 30 and 30 are disposed such that the free end 32c of the upper member 32 of the battery holder 30 does not interfere with the other battery holder 30, it is possible to prevent the free end 32c of the upper member 32 of the battery holder 30 from interfering with the other battery holder 30. In other words, when the following Equation (1) is established, the free end 32c of the upper member 32 of the battery holder 30 does not interfere with the other battery holder 30.

Lh+L1≦Lb−L2 (1)

Further, in Equation (1), the length Lh+L1 of the upper member 32 is set to be equal to or less than the thickness Lb−L2 of the battery housing 1. However, by setting the length Lh+L1 of the upper member 32 to be smaller than that in the thickness Lb−L2 of the battery housing 1 (Lh+L1<Lb−L2), the gap G may be definitely formed between the free end 32c of the upper member 32 of the battery holder 30 and the other battery holder 30.

Next, as illustrated in FIG. 5(b), there is assumed a case where the dimensional tolerance ±L2 of the thickness Lb of the battery housing 1 is a positive maximum value +L2 and the thickness Lb of the battery housing 1 is maximized to be Lb+L2, and a case where the dimensional tolerance ±L1 of the length Lh of the upper member 32 is a negative maximized value −L1 and the length Lh of the upper member 32 is minimized to be Lh−L1. In this case, when a gap in the direction of the thickness Lb of the battery housing is not formed between the free ends 32c of the upper members 32 of the pair of battery holders 30 and 30 facing each other in the direction of the thickness Lb of the battery housing 1, the vicinity of the opening 6a of the gas discharge valve 6 can be surrounded without a gap. In other words, when the following Equation (2) is established, the opening 6a of the gas discharge valve 6 can be surrounded by the upper members 32 of the pair of battery holders 30.

2×(Lh−L1)≧Lb+L2 (2)

In this embodiment, the upper members 32 and 32 of the pair of battery holders 30 and 30 facing each other in the direction of the thickness Lb of the battery housing 1 are adjacently disposed without a gap in the direction of the width W of the battery housing 1 (that is, a direction parallel to the wide surface 2a and the upper surface 3a), and the side surfaces 32d and 32d abut on each other. Therefore, in the pair of battery holders 30 and 30 facing each other in the direction of the thickness Lb of the battery housing 1 illustrated in FIG. 5(c), when a dimension from the main body member 31 of the battery holder 30 to the free end 32c of the upper member 32 is X1, and a dimension from the main body member 31 of the battery holder 30 to the free end 32c of the upper member 32 of the other battery holder 30 is X2, and in a case where the following Equation (3) is established, airtightness between the upper members 32 and 32 of the pair of battery holders is secured.

X1−X2≧0 (3)

Based on Equations (1) and (2), the length Lh of the upper member 32 along the direction of the thickness Lb of the battery housing 1 is set to meet the condition of the following Equation (4).

0.5×(Lb+L2)+L1≦Lh≦Lb−L2−L1 (4)

For example, when the thickness Lb of the battery housing 1 is set to 12.5 mm, the dimensional tolerance ±L2 of the thickness Lb is set to ±0.5 mm, and the dimensional tolerance ±L1 of the length Lh of the upper member is set to ±0.5 mm, the length Lh of the upper member 32 becomes 7.0 mm≦Lh≦11.5 mm based on Equation (4).

In a case where a graphite or silicon-based active material is used as a negative electrode material contained in a negative electrode mixture layer of a negative metal foil surface provided in the negative electrode of the secondary battery 10, the battery housing 1 may be expanded due to an expansion of the wound electrode group 9 according to charging/discharging of the secondary battery 10. At this time, in consideration of a change ±L3 in the thickness Lb of the expanding/contracting battery housing 1, the thickness Lb of the battery housing 1 in Equation (1) is set to Lb−L3, and the thickness Lb of the battery housing 1 in Equation (2) is set to Lb+L3. In this case, the length Lh of the upper member 32 along the direction of the thickness Lb of the battery housing 1 is set to satisfy the condition of the following Equation (5).

0.5×(Lb+L2+L3)+L1≦Lh≦Lb−L3−L2−L1 (5)

For example, when the thickness Lb of the battery housing 1 is set to 12.5 mm, the dimensional tolerance ±L2 of the thickness Lb is set to ±0.5 mm, the dimensional tolerance ±L1 of the length Lh of the upper member 32 is set to ±0.5 mm, and the change ±L3 in the thickness Lb of the expanding/contracting battery housing 1 is set to ±0.5 mm, the length Lh of the upper member 32 becomes 7.25 mm≦Lh≦11.0 mm based on Equation (5).

As illustrated in FIG. 3, the side member 33 is provided to be perpendicular to the main body member 31, and connected to the main body member 31 at the center in a direction of a width W3 of the side member 33 along the direction of the thickness Lb of the battery housing 1. The side member 33 is provided to be perpendicular to the main body member 31 at both ends of the main body member 31 in the direction of the width W of the battery housing 1 along the wide surface 2a and the upper surface 3a of the battery housing 1. The outer surface of the side member 33 on both sides in the direction of the width W of the battery housing 1 is formed with stepped portions 33a and 33a which are stepped to be thin with respect to the upper and lower end portions and are dented in a stepped shape with respect to the center portion. The stepped portions 33a and 33a are engaged with the above-described metal band 50.

A convex portion 33b and a concave portion 33c are provided in the outer portion in the direction of the width W of the battery housing 1 of the side member 33. The convex portion 33b is provided at one end in the direction of the width W3 of the side member 33 to protrude in the direction of the width W3. The concave portion 33c is provided on the opposite side in the direction of the width W3, and dented in the direction of the width W3. As illustrated in FIG. 4, the pair of facing battery holders 30 and 30 are integrally coupled when the convex portion 33b of the battery holder 30 adjacent in the direction of the thickness Lb of the battery housing 1 is engaged with the concave portion 33c of the other battery holder 30.

### (Gas Conduit Member)

Next, the description will be made about the gas conduit member 20 which discharges the gas released from the gas discharge valve 6 of the secondary battery 10 to the outside.

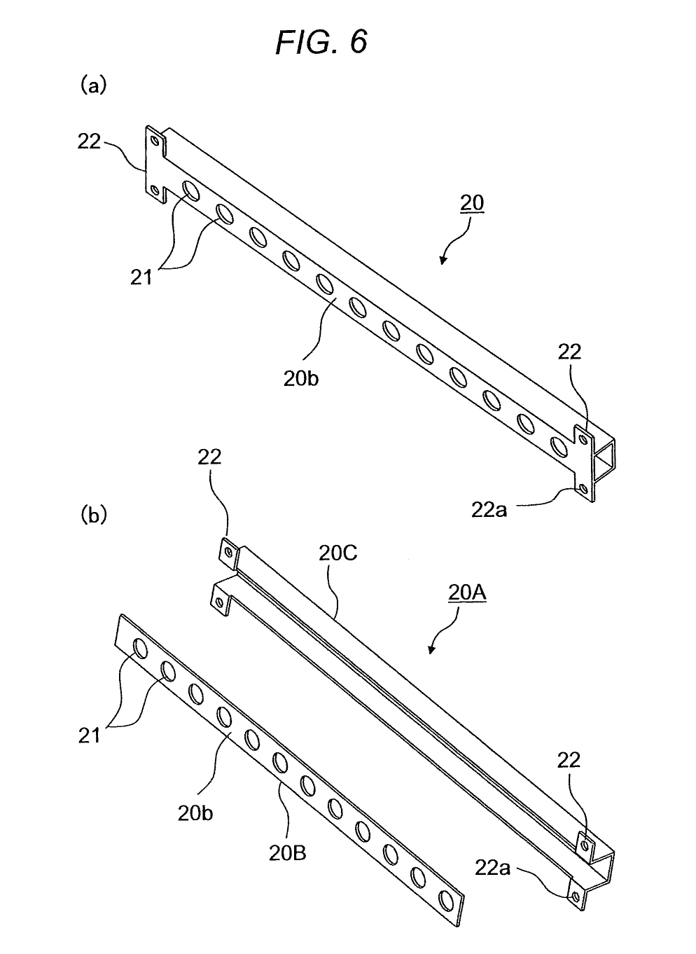

FIG. 6(a) is a perspective view of the gas conduit member 20 of this embodiment, and FIG. 6(b) is an exploded perspective view illustrating a modification of the gas conduit member 20. FIG. 7 is an enlarged cross-sectional view taken along a line VII-VII of FIG. 1.

For example, the gas conduit member 20 is formed in a rectangular cylinder shape using a resin material or a metal material and extended in the lamination direction of the secondary battery 10, includes a plurality of apertures 21 in the lower surface 20b, and includes the flange portions 22 on both ends. A through hole 22a is formed in the flange portion 22. As illustrated in FIG. 1, the bolt 45 is inserted into the through hole 22a to be screwed to the screw hole 43 of the coupling portion 42 of the end plate 40, and thus the gas conduit member 20 is fixed in the lamination direction of the secondary battery 10 to traverse the assembled battery 100. Each of the plurality of apertures 21 of the lower surface 20b of the gas conduit member 20 is provided at a position corresponding to the gas discharge valve 6 of the upper surface 3a of the secondary battery 10 and, for example, at least a part thereof faces the gas discharge valve 6. In this embodiment, a center axis C1 of the gas discharge valve 6 and a center axis C2 of the aperture 21 of the gas conduit member 20 are decentered in the direction of the thickness Lb of the battery housing 1.

In addition, the lower surface 20b of the gas conduit member 20 abuts on the upper surface 32a of the upper member 32 of the battery holder 30 (see FIG. 4). Each aperture 21 is brought into a state of being surrounded by the upper member 32 similarly to the opening 6a of the gas discharge valve 6 of the upper surface 3a of the battery housing 1. The aperture 21 of the gas conduit member 20 is open to the gas passage 60 where the upper member 32 of the battery holder 30 is partitioned, and the gas conduit member 20 communicates to make a fluid flow to the gas passage 60. Further, the gas conduit member 20 may be integrally provided as illustrated in FIG. 6(a). As the example of a gas conduit member 20A illustrated in FIG. 6(b), the gas conduit member 20 may be configured by a channel portion 20C of which the lower surface is open and a bottom plate 20B which includes the plurality of apertures 21.

Next, the description will be made about an operation of the assembled battery 100 of this embodiment configured as follows.

In the secondary battery 10 provided in the assembled battery 100, the battery housing 1 is expanded or contracted due to the expansion/contraction of the wound electrode group 9 at the time of charging/discharging. However, the assembled battery 100 includes the metal band 50 which is designed to have a mechanical strength enough for fixing the laminated body configured by the secondary battery 10, the battery holder 30, and the end battery holder 30E, and fastens and fixes the laminated body in the lamination direction by the pair of end plates 40 and the metal band 50. In addition, the assembled battery 100 is configured such that the metal band 50 is engaged with the stepped portion 33a of the side member 33 of the battery holders 30 and 30E to prevent the releasing from the battery holders 30 and 30E, and to prevent the secondary battery 10 interposed between the battery holders 30 and 30E from being disengaged.

With such a configuration, the wide surface 2a of the battery housing 1 of the secondary battery 10 is constrained by the battery holder 30 and the end battery holder 30E, so that the expansion of the battery housing 1 can be suppressed. Therefore, the assembled battery 100 of this embodiment can be suppressed from that the secondary battery 10 is shortened in life property due to the expansion of the battery housing 1 of the secondary battery 10. In addition, the adjacent secondary batteries 10 can be electrically insulated by the battery holder 30, and also the adjacent secondary batteries 10 can be thermally disconnected.

In addition, in the assembled battery 100, for example, when the internal pressure of the battery housing 1 is increased up to a predetermined value due to the overheating of the battery housing 1 caused by the short-circuit or the overcharging of the secondary battery 10, the gas discharge valve 6 is cleaved to cause the gas in the battery housing 1 to be discharged so as to lower the internal pressure, so that the explosion of the battery housing 1 is prevented.

Herein, the upper members 32 of the battery holders 30 and 30E provided in the assembled battery 100 of this embodiment are configured such that the lower surface 32b abuts on the upper surface 3a of the battery housing 1 and the upper surface 32a abuts on the lower surface 20b of the gas conduit member 20. The upper members 32 surround the opening 6a of the gas discharge valve 6 of the upper surface 3a of the battery housing 1 and surround the aperture 21 of the lower surface 20b of the gas conduit member 20. With such a configuration, the gas passage 60 is partitioned by the upper members 32 to make a fluid communicate between the gas discharge valve 6 of the battery housing 1 and the gas conduit member 20, and airtightness of the gas passage 60 with respect to the upper surface 3a of the battery housing 1 and the lower surface 20b of the gas conduit member 20 can be secured. Therefore, when the gas released from the gas discharge valve 6 through the gas passage 60 is released to the gas conduit member 20, a gas leakage to the outside of the gas passage 60 can be prevented, and the gas released from the gas discharge valve 6 can be securely discharged to the gas conduit member 20.

Furthermore, the upper member 32 of the battery holders 30 and 30E is extended in the direction of the thickness Lb of the battery housing 1 along the upper surface 3a of the battery housing 1, and the one end thereof is fixedly supported to the main body member 31 and the other end is the free end 32c. Therefore, the dimensional tolerance of the battery housing 1 and the battery holders 30 and 30E and the change in dimension due to the expansion of the battery housing 1 according to the charging/discharging of the secondary battery 10 can be absorbed between the pair of battery holders 30 and 30 (or 30 and 30E) facing each other in the direction of the thickness Lb of the battery housing 1. In other words, in the pair of battery holders 30 and 30 facing each other in the direction of the thickness Lb of the battery housing 1, the gap G between the free end 32c of the upper member 32 of the battery holder 30 and the other battery holder 30 facing the free end 32c can be changed according to the dimensional tolerance and the change in dimension of the battery housing 1. Therefore, while securing the airtightness of the gas passage 60 which makes a fluid communicate between the gas discharge valve 6 and the gas conduit member 20, the dimensional tolerance and the change in dimension of the battery housing 1 can be allowed.

In addition, in the pair of battery holders 30 and 30 facing each other in the direction of the thickness Lb of the battery housing 1, since the gap G is set between the upper member 32 of the battery holder 30 and the other battery holder 30, it is possible to securely prevent the free end 32c of the upper member 32 of the battery holder 30 from interfering with the other battery holder 30 due to the dimensional tolerance and the change in dimension of the battery housing 1.

As described above, according to the assembled battery 100 of this embodiment, there is no need to make precise alignment when a flow passage for discharging the gas released from the gas discharge valve 6 is configured by the gas passage 60 and the gas conduit member 20. The dimensional tolerance of the secondary battery 10 can be allowed, and the airtightness of the flow passage can be secured regardless of the expansion/contraction of the secondary battery 10.

### (First Modification of Battery Holder)

In the above-described first embodiment, the description has been made about the case that the upper member 32 of the battery holder 30 is parallel to the direction of the thickness Lb of the battery housing 1, but the upper member 32 may be inclined with respect to the direction of the thickness Lb of the battery housing 1. Hereinafter, a first modification of the battery holder 30 will be described.

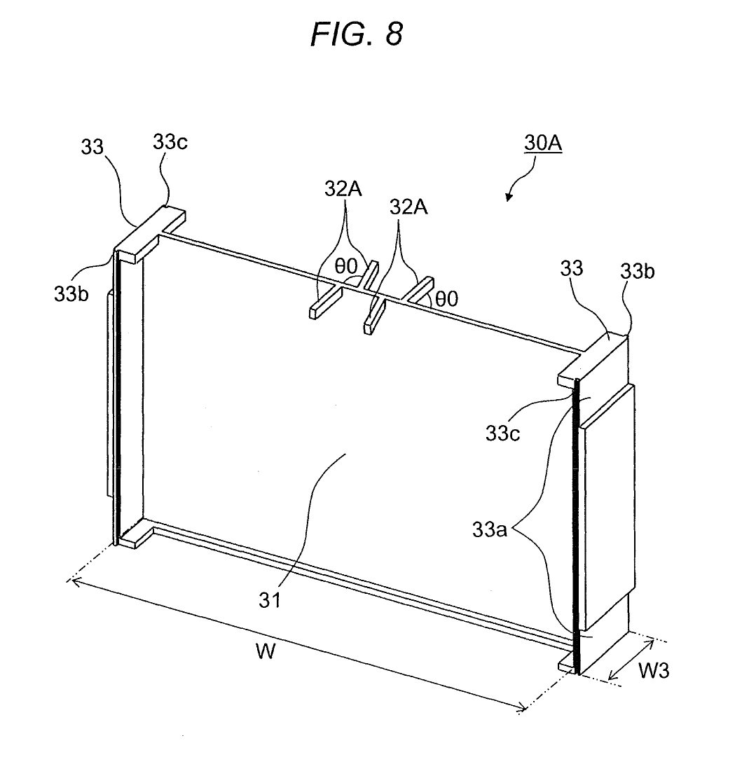

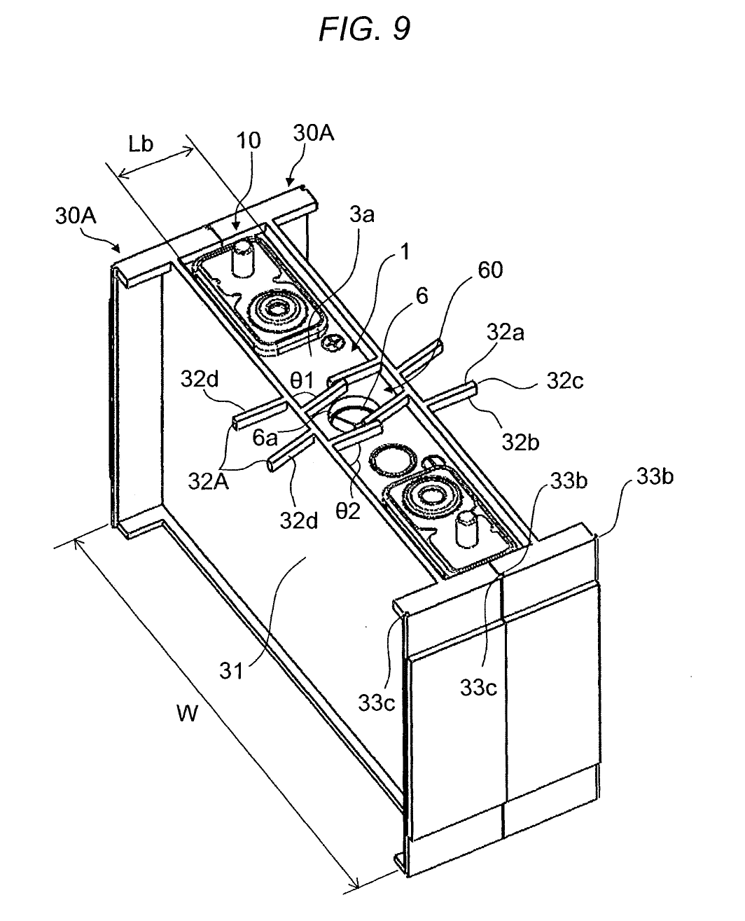

FIG. 8 is a perspective view illustrating the first modification of the battery holder 30 included in the assembled battery 100 of the above-described first embodiment. FIG. 9 is a perspective view illustrating an assembled state of a battery holder 30A of the first modification illustrated in FIG. 8 and the secondary battery 10.

The battery holder 30A of the first modification is different from the battery holder 30 of the above-described first embodiment in that an upper member 32A is inclined with respect to the direction of the thickness Lb of the battery housing 1. Since the other configurations are the same as those of the battery holder 30 of the above-described first embodiment, the same configurations will be denoted with the same symbols and the descriptions thereof will not be repeated.

The upper members 32A of the battery holder 30A of the first modification provided on both sides of the gas discharge valve 6 are inclined with respect to the direction of the thickness Lb of the battery housing 1 such that a gap therebetween is widened as it goes separate from the main body member 31. In addition, the battery holder 30A may be made of, for example, the resin material described above to cause the upper member 32A to be elastically deformable at the time of assembling the battery holder 30A.

In this case, an angle θ1 between the main body member 31 and the upper member 32A which is disposed inside the gas passage 60 partitioned by the upper members 32A of the assembled battery holders 30A illustrated in FIG. 9 is desirably made larger than a tilt angle θ0 of the upper member 32A of the battery holder 30A with respect to the main body member 31 in the exploded state illustrated in FIG. 8. In addition, an angle θ2 formed between the main body member 31 and the upper member 32A which is disposed outside the gas passage 60 illustrated in FIG. 9 is desirably made smaller than the tilt angle θ0 of the upper member 32A of the battery holder 30A with respect to the main body member 31 in the exploded state illustrated in FIG. 8. With such a configuration, the side surface 32d of the upper member 32A of the battery holder 30 facing in the direction of the thickness Lb of the battery housing 1 is applied with an urging force to the side surface 32d of the upper member 32A of the other battery holder 30A, so that these side surfaces are tightly closed. Therefore, it is possible to improve the airtightness.

### (Second Modification of Battery Holder)

In addition, the description in the above-described first embodiment has been made about that the upper members 32 of the battery holder 30 are provided to interpose the gas discharge valve 6 on both sides, and a plurality of upper members 32 may be provided on either side of the gas discharge valve 6. Hereinafter, a second modification of the battery holder 30 will be described.

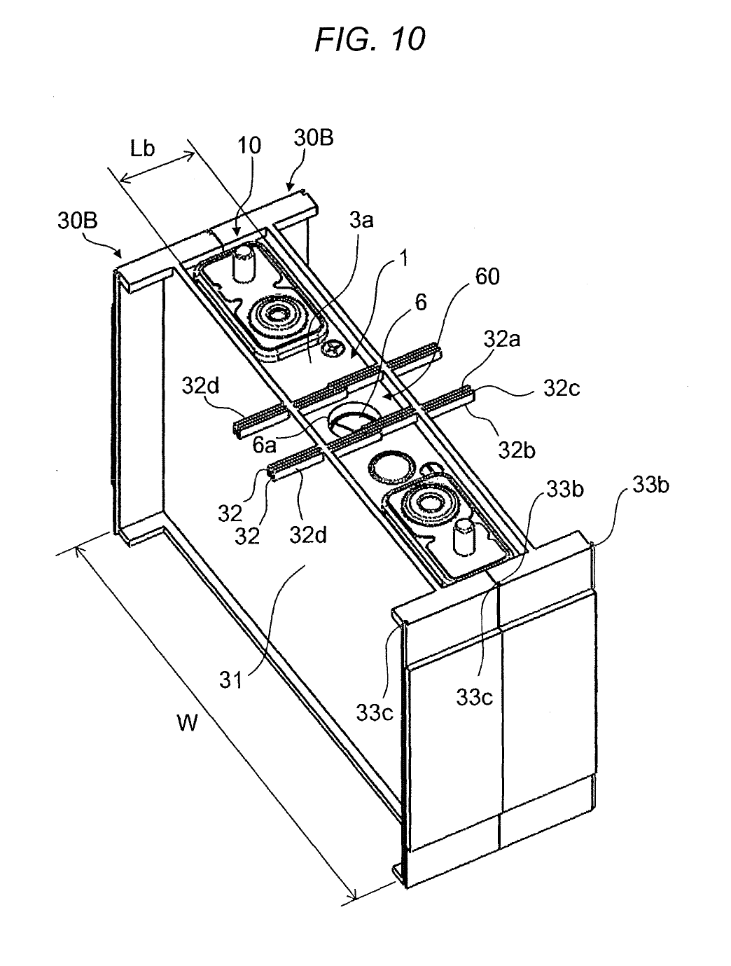

FIG. 10 is a perspective view illustrating an assembled state of a battery holder 30B of the second modification and the secondary battery 10.

The battery holder 30B of the second modification is different from the battery holder 30 of the above-described first embodiment in that a plurality of upper members 32 are provided on both sides of the gas discharge valve 6. Since the other configurations are the same as those of the battery holder 30 of the above-described first embodiment, the same configurations will be denoted with the same symbols and the descriptions thereof will not be repeated.

The battery holder 30B includes the plurality of upper members 32 on both sides of the gas discharge valve 6 in the direction of the width W of the battery housing 1. In this modification, two upper members 32 are provided on both sides of the gas discharge valve 6. The upper members 32 of the pair of battery holders 30B and 30B facing each other in the direction of the thickness Lb of the battery housing 1 are desirably alternately disposed in the direction of the width W of the battery housing 1. With such a configuration, a labyrinth seal is formed by the plurality of upper members 32, so that the airtightness of the gas passage 60 can be more improved.

### Second Embodiment

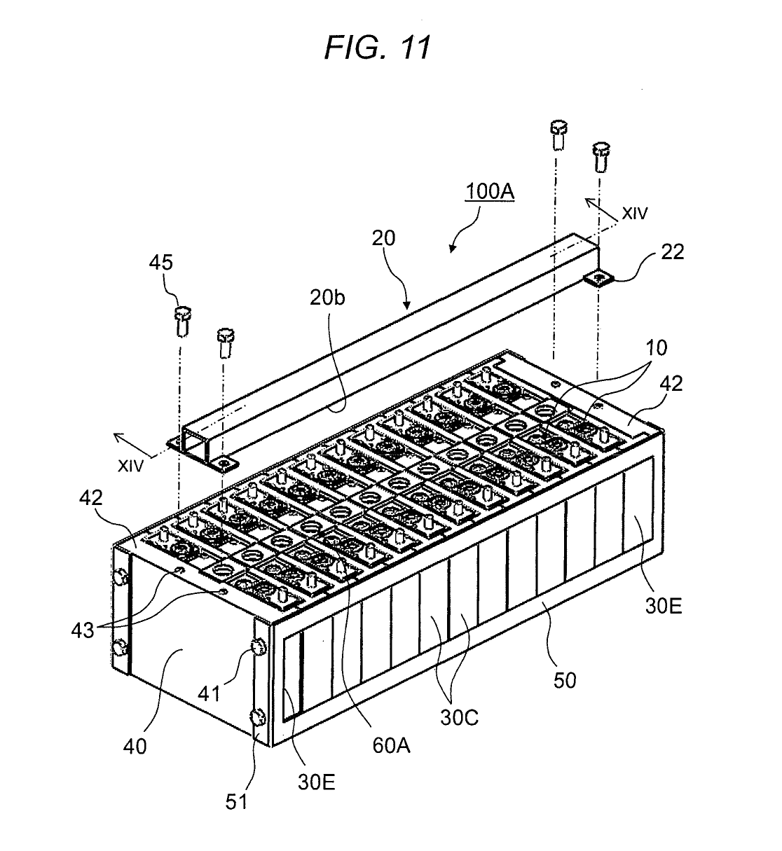

Next, a second embodiment of an assembled battery of the invention will be described using FIGS. 11 to 15(b) while employing FIGS. 2 and 6(b).

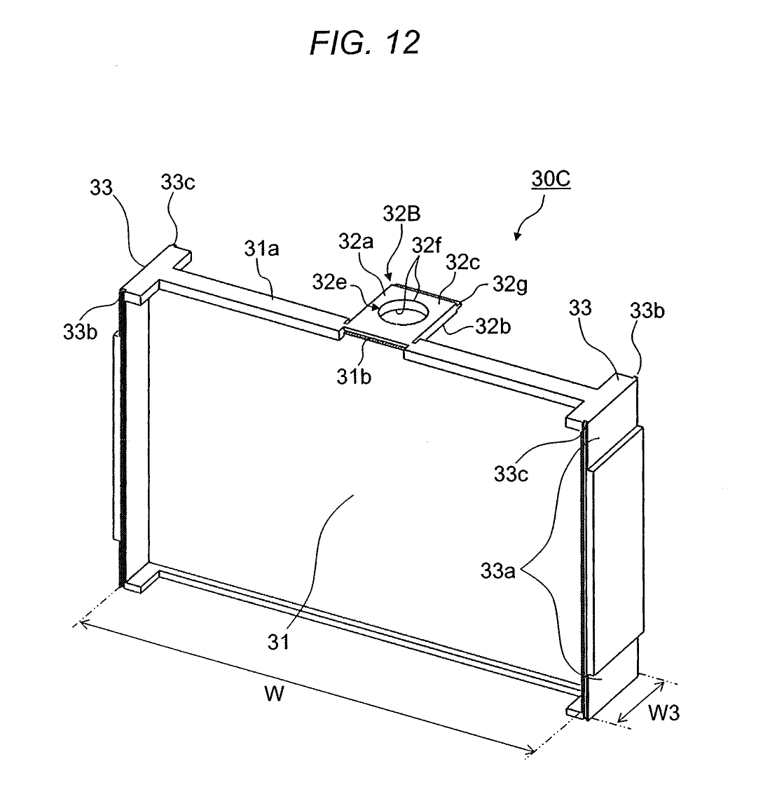

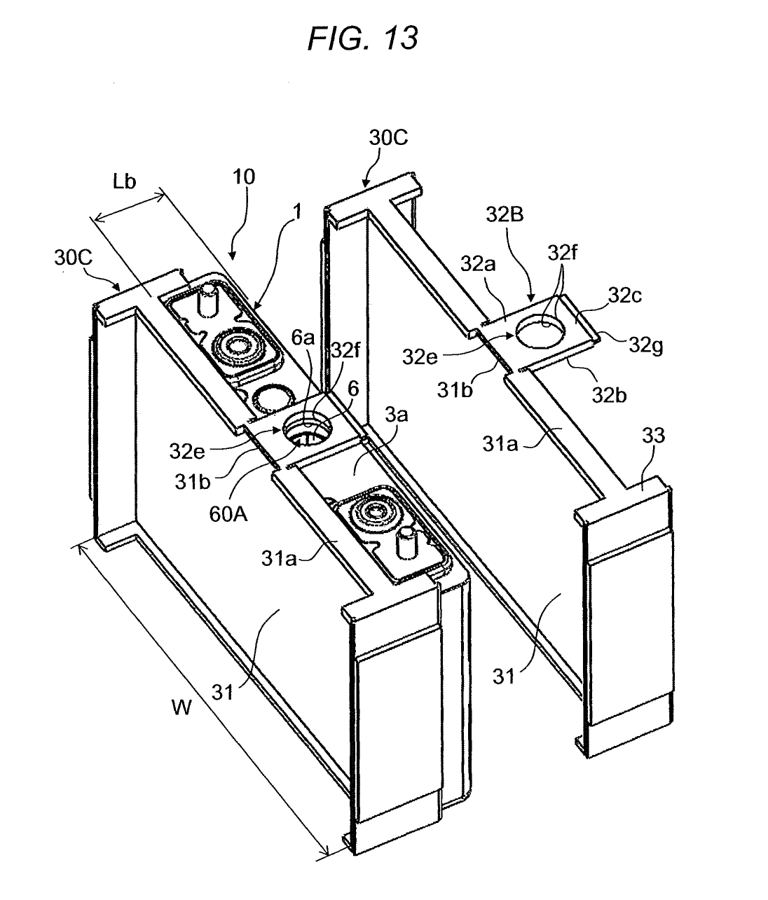

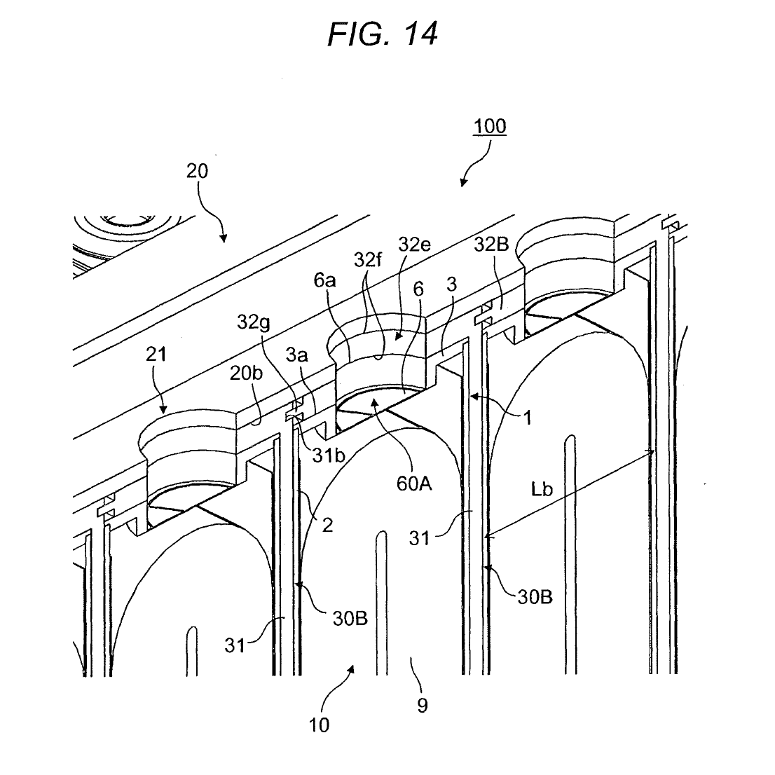

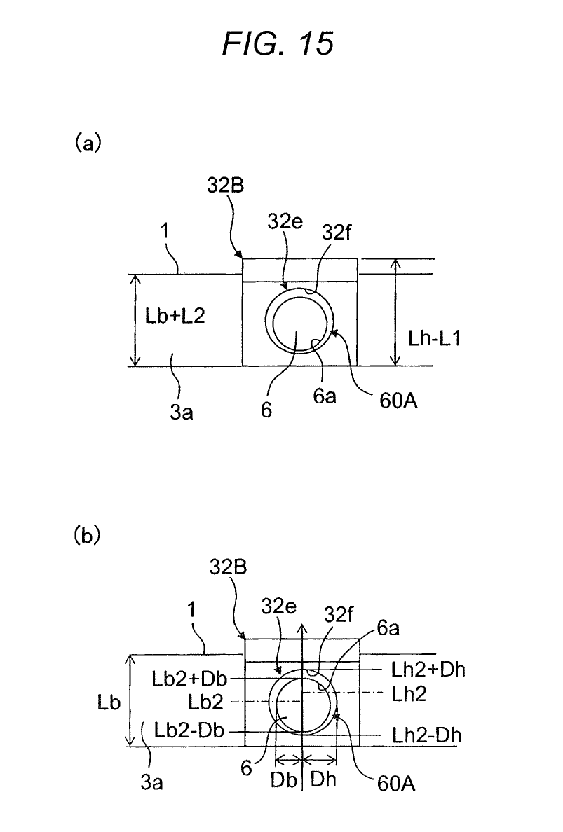

FIG. 11 is an exploded perspective view of an assembled battery 100A according to the second embodiment. FIG. 12 is a perspective view of a battery holder 30C provided in the assembled battery 100A illustrated in FIG. 11. FIG. 13 is an exploded perspective view illustrating the secondary battery 10 provided in the assembled battery 100A illustrated in FIG. 11 and the pair of battery holders 30C and 30C on both sides thereof. FIG. 14 is an enlarged cross-sectional view of the assembled battery 100A taken along a line XIV-XIV of FIG. 11. FIGS. 15(a) and 15(b) are enlarged plan views illustrating a positional relation between a through hole 32e of an upper member 32B of the battery holder 30C illustrated in FIG. 13 and the opening 6a of the gas discharge valve 6 of the secondary battery 10.

The battery holder 30C provided in the assembled battery 100A of the this second embodiment is different from the battery holder 30 of the above-described first embodiment in that the upper member 32B includes the through hole 32e and the opening 6a of the gas discharge valve 6 is disposed inside an opening 32f of the through hole 32e. Since the other configurations are the same as those of the battery holder 30 of the first embodiment, the same configurations will be denoted with the same symbols and the descriptions thereof will not be repeated.

The upper member 32B is formed in a rectangular shape extending in the direction of the thickness Lb of the battery housing 1 along the upper surface 3a of the battery housing 1 and includes the through hole 32e in the center portion. The upper member 32B is configured such that the one end thereof is fixedly supported to the upper end of the main body member 31 and the other end is the free end 32c. The through hole 32e of the upper member 32B reaches the upper surface 32a from the lower surface 32b of the upper member 32B, the opening 6a of the gas discharge valve 6 is disposed inside the opening 32f on a side near the lower surface 32b, and the aperture 21 of the gas conduit member 20 is disposed inside or overlapping with the opening 32f on a side near the upper surface 32a. The upper member 32B is configured such that the lower surface 32b abuts on the upper surface 3a of the battery housing 1 and the upper surface 32a abuts on the lower surface 20b of the gas conduit member 20 so that a gas passage 60A is partitioned to cause a fluid to communicate between the gas discharge valve 6 and the gas conduit member 20 by the through hole 32e.

The battery holder 30C includes an edge portion 31a which is extended in the direction of the width W of the battery housing 1 along the upper end of the main body member 31. The edge portion 31a protrudes perpendicular to the main body member 31 with a predetermined width on both sides in the direction of the thickness Lb of the battery housing 1 from the surface of the main body member 31 facing the wide surface 2a of the battery housing 1. The upper member 32B is provided in the center portion in the extension direction of the edge portion 31a, and is provided with an engaging portion 31b which is formed in a groove shape by making a notch in the base portion of the edge portion 31a in the direction of the thickness Lb of the battery housing 1. The free end 32c of the upper member 32B of the other battery holder 30B facing in the direction of the thickness Lb of the battery housing 1 is engaged with the engaging portion 31b.

A thin portion 32g having a small thickness is provided in the free end 32c of the upper member 32B. A stepped portion is formed in the upper surface 32a and the lower surface 32b of the free end 32c by providing the thin portion 32g, and a projection protruding in the direction of the thickness Lb of the battery housing 1 is formed in the free end 32c. When the thin portion 32g of the projection shape is engaged with the engaging portion 31b of the groove shape, the free end 32c of the upper member 32B is engaged with the engaging portion 31b. With such a configuration, the free end 32c of the upper member 32B of the battery holder 30C facing in the direction of the thickness Lb of the battery housing 1 is overlapped with the engaging portion 31b of the other battery holder 300 in a direction perpendicular to the upper surface 3a of the battery housing 1 (that is, a thickness direction of the upper member 32B) so as to be engaged with each other.

Herein, the size of the through hole 32e of the upper member 32B of the battery housing 1 is desirably set as described below for example.

FIGS. 15(a) and 15(b) are enlarged views illustrating the vicinity of the gas discharge valve 6 in plan view of the battery housing 1.

Further, for the sake of simplicity in the following description, it is assumed that there is provided a sufficient gap in the direction of the thickness Lb of the battery housing 1 between the free end 32c of the upper member 32B of the battery holder 30C facing in the direction of the thickness Lb of the battery housing 1 and the engaging portion 31b of the other battery holder 30C. Therefore, it is assumed that the gap is always formed in the direction of the thickness Lb of the battery housing 1 between the free end 32c of the upper member 32B of the battery holder 30C and the engaging portion 31b of the other battery holder 30B regardless of the dimensional tolerance of the battery housing 1 and the battery holder 30C and the expansion/contraction of the battery housing 1.

In addition, it is assumed that the center of the opening 6a of the gas discharge valve 6 of the upper surface 3a of the battery housing 1 is at a center position Lb2 in the direction of the thickness Lb of the battery housing 1, and the center of the opening 32f of the through hole 32e of the upper member 32B is at a center position Lh2 in the direction of the length Lh of the upper member 32B, and there is no dimensional tolerance at the respective positions.

The length of the upper member 32B along the direction of the thickness Lb of the battery housing 1 is set to Lh, and the dimensional tolerance of the length Lh is set to ±L1. The thickness of the battery housing 1 is set to Lb, and the dimensional tolerance of the thickness Lb is set to ±L2. The radius of the through hole 32e of the upper member 32B is set to Dh, and the radius of the opening 6a of the gas discharge valve 6 is set to Db. At this time, the radius Dh of the through hole 32e of the upper member 32B is determined as follows for example.

As illustrated in FIG. 15(a), there is assumed a case where the dimensional tolerance ±L2 of the battery housing 1 becomes a positive maximum value +L2 and the thickness Lb of the battery housing 1 is maximized to be Lb+L2, and a case where the dimensional tolerance ±L1 of the upper member 32B becomes a negative maximum value −L1 and the length Lh of the upper member 32B is minimized to be Lh−L1. In this case, the following Equation (6) is established.

Lh−L1>Lb+L2 (6)

Next, when the upper surface 3a of the battery housing 1 illustrated in FIG. 14(b) is viewed in plan, it is assumed that the airtightness of the gas passage 60A is secured in a case where the opening 6a of the gas discharge valve 6 is at a position inside the opening 32f of the through hole 32e of the upper member 32B or a position overlapping with the opening 32f. Then, the radius Dh of the through hole 32e of the upper member 32B and the radius Db of the opening 6a of the gas discharge valve 6 necessarily satisfy the conditions of the following Equations (7) and (8).

Lh2+Dh≧Lb2+Db (7)

Lh2−Dh≦Lb2−Db (8)

When Equations (7) and (8) are rearranged by the radius Dh of the through hole 32e of the upper member 32B, the conditions to be satisfied by the radius Dh are expressed as the following Equations (9) and (10).

Dh≧Db+(Lb2−Lh2) (9)

Dh≧Db−(Lb2−Lh2) (10)

In addition, since the following Equation (11) is established based on Equation (1), the condition to be satisfied by the radius Dh of the through hole 32e is expressed as the following Equation (12).

Lb2−Lh2<0 (11)

Dh≧Db−(Lb2−Lh2) (12)

When Equation (12) is further rearranged by the length Lh of the upper member 32B and the thickness Lb of the battery housing 1 using the following Equation (13), the conditions to be satisfied by the radius Dh of the through hole 32e are finally expressed by the following Equations (14) and (15).

(Lh2, Lb2)=0.5×(Lh±L1, Lb±L2) (13)

0.5×(Lh−L1)≧Dh (14)

Dh≧Db−0.5×{(Lb−Lh)−(L1+L2)} (15)

For example, when the length Lh of the upper member 32B is set to 14.0 mm, the dimensional tolerance ±L1 of the length Lh is set to ±0.5 mm, the thickness Lb of the battery housing 1 is set to 12.5 mm, the dimensional tolerance ±L2 of the thickness Lb is set to ±0.5 mm, and the radius Db of the opening 6a of the gas discharge valve 6 is set to 3.0 mm, the radius Dh of the through hole 32e becomes 4.25 mm≦Dh≦6.75 mm based on Equations (14) and (15).

In a case where the change in the thickness Lb of the battery housing 1 according to the charging/discharging of the secondary battery 10 is considered, the radius Dh of the through hole 32e of the upper member 32B can be calculated by setting the change in the thickness Lb of the battery housing 1 according to the charging/discharging of the secondary battery 10 to ±L3, and by replacing the thickness Lb of the battery housing 1 with Lb±L3. When the radius Dh of the through hole 32e is set as described above, regardless of the dimensional tolerance of the battery housing 1 and the battery housing 1 and the expansion of the battery housing 1, the opening 6a of the gas discharge valve 6 can be more securely disposed at a position inside the opening 32f of the through hole 32e of the upper member 32 or a position overlapping with the opening 32f.

According to the assembled battery 100A of this embodiment, similarly to the assembled battery 100 of the first embodiment, it is possible to form the gas passage 60A through which a fluid communicates between the gas discharge valve 6 and the gas conduit member 20 using the through hole 32e of the upper member 32B of the battery holder 30C. Therefore, similarly to the assembled battery 100 of the first embodiment, when the gas released from the gas discharge valve 6 through the gas passage 60A is released to the gas conduit member 20, a gas leakage to the outside of the gas passage 60A can be prevented, and the gas released from the gas discharge valve 6 can be securely discharged to the gas conduit member 20.

In addition, similarly to the assembled battery 100 of the first embodiment, the upper member 32B of the battery holder 30C is extended in the direction of the thickness Lb of the battery housing 1 along the upper surface 3a of the battery housing 1, and the one end is supported by the main body member 31 and the other end is the free end 32c. Therefore, the dimensional tolerance of the battery housing 1 and the battery holder 30C and the change in dimension due to the expansion of the battery housing 1 according to the charging/discharging of the secondary battery 10 can be absorbed between the pair of battery holders 30C and 30C facing each other in the thickness direction of the battery housing 1. Further, while securing the airtightness of the gas passage 60A, the dimensional tolerance and the change in dimension of the battery housing 1 can be allowed.

In addition, the assembled battery 100A includes the engaging portion 31b through which the free end 32c of the upper member 32B of the battery holder 30C and the other battery holder 30C in the pair of battery holders 30C and 30C facing each other in the direction of the thickness Lb of the battery housing 1 are engaged to be overlapped with each other in a direction perpendicular to the upper surface 3a of the battery housing 1. Therefore, it is possible to improve an engagement strength of the pair of battery holders 30C and 30C facing each other in the direction of the thickness Lb of the battery housing 1.

As described above, according to the assembled battery 100A of this embodiment, there is no need to make precise alignment when a flow passage for discharging the gas released from the gas discharge valve 6 is configured by the gas passage 60A and the gas conduit member 20. The dimensional tolerance of the secondary battery 10 and the battery holder 300 can be allowed, and the airtightness of the flow passage can be secured regardless of the expansion/contraction of the secondary battery 10.

### (Third Modification of Battery Holder)

In the above-described second embodiment, the description has been made about a case where the upper surface of the upper member 32B is flat, but the upper surface of the upper member 32B is not necessarily flat. Hereinafter, a third modification of the battery holder 30C of the second embodiment will be described.

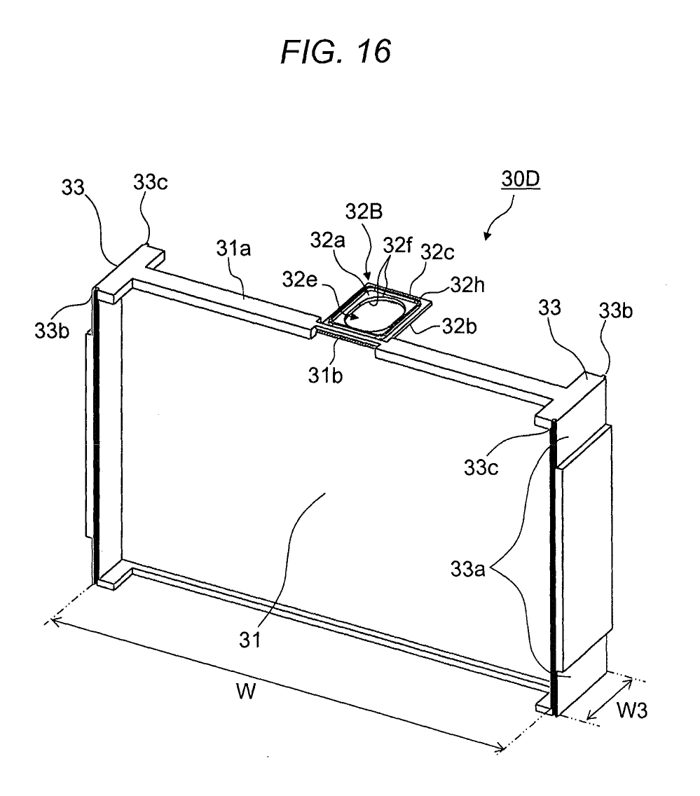

FIG. 16 is a perspective view illustrating the third modification of the battery holder 30C provided in the assembled battery 100A of the above-described second embodiment.

A battery holder 30D of the third modification is different from the battery holder 30C of the above-described second embodiment in that the upper member 32B includes a contact portion 32h in the upper surface 32a. Since the other configurations are the same as those of the battery holder 30C of the above-described second embodiment, the same configurations will be denoted with the same symbols and the descriptions thereof will not be repeated.

The upper member 32B includes the contact portion 32h of a frame shape extending (for example, vertically upward) from the upper surface 32a of the upper member 32B. The upper member 32B abuts on the lower surface 20b of the gas conduit member 20 through the contact portion 32h. In this way, the pressure of the contact surface between the upper surface 32a of the upper member 32B and the gas conduit member 20 is increased by providing the contact portion 32h of the frame shape in the upper surface 32a of the upper member 32B, and thus a sealing property of the gas passage 60A can be improved. Further, the upper member 32B may include the similar contact portion 32h of the upper surface 32a in the lower surface 32b. In this case, the pressure of the contact surface between the lower surface 32b of the upper member 32B and the upper surface 3a of the battery housing 1 is increased, so that the sealing property of the gas passage 60A can be improved. In addition, a plan shape of the through hole 32e of the upper member 32B is not limited to a circular shape, but may be a long hole such as an elliptical shape or an oval shape extending in the direction of the thickness Lb of the battery housing 1. In this case, the width of the upper member 32B along the direction of the width W of the battery housing 1 can be made narrow.

Hitherto, the embodiments of the invention has been described using the drawings, but the specific configurations are not limited to the embodiments. Even when the design is changed within a scope not departing from the spirit of the invention, these changes fall within the invention.

The assembled battery of the invention may be applied, for example, to an assembled battery mounted in an in-vehicle battery system which is applied to a hybrid automobile having a motor as a driving source or a zero-emission electric automobile. In addition, the battery system mounted with the assembled battery of the invention is not limited to the above-described usage, and can be used as a battery system for charging and storing the battery with power generated by photovoltaic power generation or wind power generation regardless of a home usage, a business usage, or an industrial usage. In addition, the battery system mounted with the assembled battery of the invention may be used as a battery system which charges and stores the battery using midnight power of the nighttime, or a battery system which can be used in other than the ground such as a space station, a space craft, or a space center. Furthermore, the battery system mounted with the assembled battery of the invention may be used for an industrial field such as a medical machine, a construction machine, a power storage system, an elevator, and an unmanned traveling vehicle, or a traveling body such as a golf cart and a turret vehicle.

### REFERENCE SIGNS LIST

1 battery housing
2a wide surface
3a upper surface of battery housing
6 gas discharge valve
6a opening of gas discharge valve
10 secondary battery
20 gas conduit member
20A gas conduit member
21 aperture
20b lower surface of gas conduit member
30 battery holder
30A battery holder
30B battery holder
30C battery holder
30D battery holder
30E battery holder
31 main body member
31b engaging portion
32 upper member
32e through hole
32f opening of through hole
32h contact portion
60 gas passage
60A gas passage
100 assembled battery
100A assembled battery
G gap
Lb thickness of battery housing

1. An assembled battery, comprising:
a plurality of secondary batteries that includes a flat-box-shaped battery housing having a gas discharge valve in an upper surface;
a battery holder that is alternately laminated with the secondary battery in a thickness direction of the secondary battery; and
a gas conduit member that is disposed on an upper portion of the gas discharge valve,
wherein the battery holder includes a main body member that abuts on a wide surface of the battery housing in the thickness direction, and an upper member of which one end is fixed to an upper end of the main body member and the other end abuts on an upper surface of the battery housing and is extended in the thickness direction, and
wherein the upper member is formed to surround the gas discharge valve and abuts on a lower surface of the gas conduit member to form a gas passage from the gas discharge valve to the gas conduit member.

2. The assembled battery according to claim 1,
wherein, in a pair of the battery holders facing each other in the thickness direction of the battery housing, a gap is provided between the upper member of the battery holder and the other battery holder.

3. The assembled battery according to claim 2,
wherein the battery holder includes the upper members on both sides of the gas discharge valve in a width direction along the upper surface and the wide surface of the battery housing, and
wherein the upper members of the pair of battery holders facing each other in the thickness direction of the battery housing are extended in a direction facing each other to overlap the free ends in the width direction of the battery housing, and side surfaces in the width direction abut on each other to form the gas passage.

4. The assembled battery according to claim 3,
wherein the upper members provided on both sides of the gas discharge valve are inclined with respect to the thickness direction of the battery housing such that a gap of the upper members is widened as it goes separate from the main body member.

5. The assembled battery according to claim 3,
wherein the battery holder includes a plurality of upper members on both sides of the gas discharge valve, and
wherein the upper members of the pair of battery holders facing each other in the thickness direction of the battery housing are alternately disposed in the width direction of the battery housing.

6. The assembled battery according to claim 2,
wherein the upper member includes a through hole that reaches the upper surface from the lower surface to form the gas passage, and an opening of the gas discharge valve is disposed inside an opening of the through hole.

7. The assembled battery according to claim 6,
wherein an engaging portion is formed to engaging the free end of the upper member of the battery holder and the other battery holder to be overlapped in a direction perpendicular to the upper surface of the battery housing in the pair of battery holders facing each other in the thickness direction of the battery housing.

8. The assembled battery according to claim 6,
wherein the upper member abuts on the lower surface of the gas conduit member through a contact portion of a frame shape extending from the upper surface of the upper member to the lower surface of the gas conduit member.

9. The assembled battery according to claim 1,
wherein a plurality of apertures are provided in the lower surface of the gas conduit member to be open to the gas passage.
